(19) United States
(12) Patent Application Publication
(10) Pub. No.: US 2005/0069147 A1
(43) Pub. Date: Mar. 31, 2005

(54) Headset wire for use with portable electronic devices

(76) Inventor: Claus Bjerre Pedersen, Aalborg (DK)

Correspondence Address: Bell, Boyd & Lloyd LLC, P.O. Box 1135, Chicago, IL, 60690-1135, US

(21) Appl. No.: 10/909,160

(22) Filed: Jul. 30, 2004

Related U.S. Application Data
(63) Continuation of application No. PCT/EP04/00938, filed on Feb. 2, 2004.

(30) Foreign Application Priority Data
Jun. 16, 2003 (EP) 03013653.5

(51) Int. Cl. H04R 1/10

(52) U.S. Cl. 381/74

(57) ABSTRACT

A headset wire for a portable electronic device is disclosed. The headset wire includes a first pair of wires electrically connectable to a first loudspeaker, a second pair of wires electrically connectable to a microphone or to a second loudspeaker and also a zipper used to releasably join or separate the pairs of wires.

### RELATED APPLICATIONS

This is a Continuation Application claiming priority under 35 U.S.C. §120 from International Patent Application No. PCT/EP2004/00938, which was filed Feb. 2, 2004, and is hereby incorporated by reference in its entirety.

### BACKGROUND

Many modern portable electronic devices are intended or suitable for recording or playback of acoustic signals. For many applications it is necessary to have a headset, that typically comprising one or more loudspeakers, which may be in the form of one or two earplugs, or one or more microphones. By using a headset, a user of a mobile phone can enjoy more privacy when the others around him or her cannot hear the telephone conversation. Further, by using a suitable microphone in the headset, the telephone call can still be successfully arrived at even though there may be much background noise.

The loudspeaker and microphone in such headsets are usually connected to the portable electronic device by using a headset wire that usually includes two pair of wires, each pair usually packed together within one insulator. An annoying feature of two wire pairs is that they get easily entangled. Because the headset is not always used, such as when the device is being transported, the headset wire is put into the pocket of the user or some other receptacle and inevitably gets tangled. A solution to this problem can be to include a reel to the device or for the headset, but this is not always acceptable, particularly if also an attractive design is also desired.

A known prior art device features a hands-free headset that includes first and second earpieces and includes two retractable cords that engage with a portable communications device. A sliding grommet attached to the retractable cords controls the separation of the cords and facilitates the two cords being reeled into a common cord reel.

Another known device features a strap having two connection members connected to each other in a loop that allows a cord section to act like a strap of a mobile phone. When the connection members are not connected in a loop, but alternatively connected in a straight line act like part of a connection cord provided to a headphone.

### SUMMARY

According to the present disclosure, a headset wire for use with a portable electronic device is disclosed. The headset wire includes a first pair of wires configured to electrically connect to a first loudspeaker and a second pair of wires configured to electrically connect to at least one of a microphone and a second loudspeaker. The headset wire also features a zipper configured to releasably join the first and second pair of wires together.

### BRIEF DESCRIPTION OF THE DRAWINGS

FIG. 1 illustrates a portable electronic device together with a headset wire.

FIG. 2 illustrates a headset wire where the slidable connecting means includes a zipper.

### DETAILED DESCRIPTION OF THE PRESENT EXAMPLES

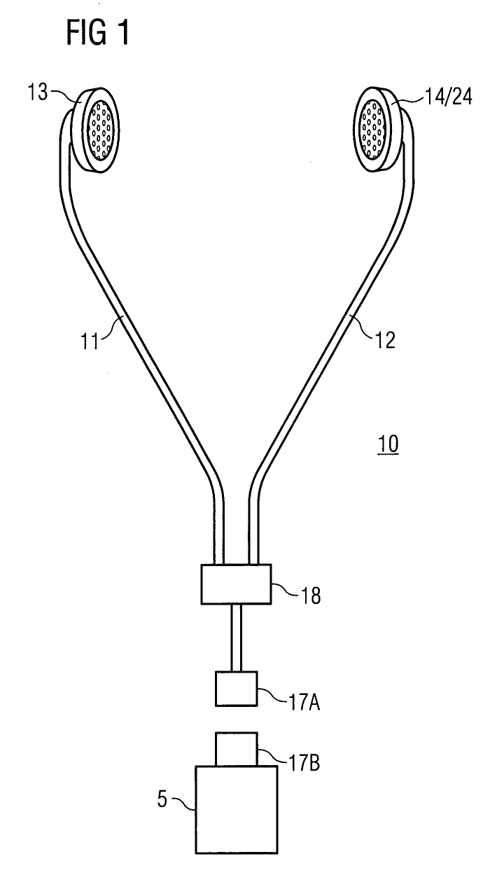

FIG. 1 illustrates a portable electronic device 5 together with a headset wire 10. The headset wire 10 can be connected to the portable electronic device 5 by plugging a connector 17A to a connector socket 17B. The headset wire 10 includes two pairs of wires 11, 12.

The first pair of wires 11 is connected to a first loudspeaker 13, and the second pair 12 is connected to a second loudspeaker 14. Instead of having an “earphone”-like solution, the second loudspeaker 14, for example, could instead be a microphone which is in the place of loudspeaker 11 in FIG. 1. Headsets of the type using first and second loudspeaker are normally used as stereo earphones, such as those used with portable CD or MP3 players, portable radios and so forth. Headsets with a loudspeaker and microphone are normally used with mobile phones and other wireless terminals. Further, the headset wire 10 includes a slidable connector 18 adapted to releasably bring the first and the second pair 11, 12 of wires closer to each other, or further, to releasably join them together.

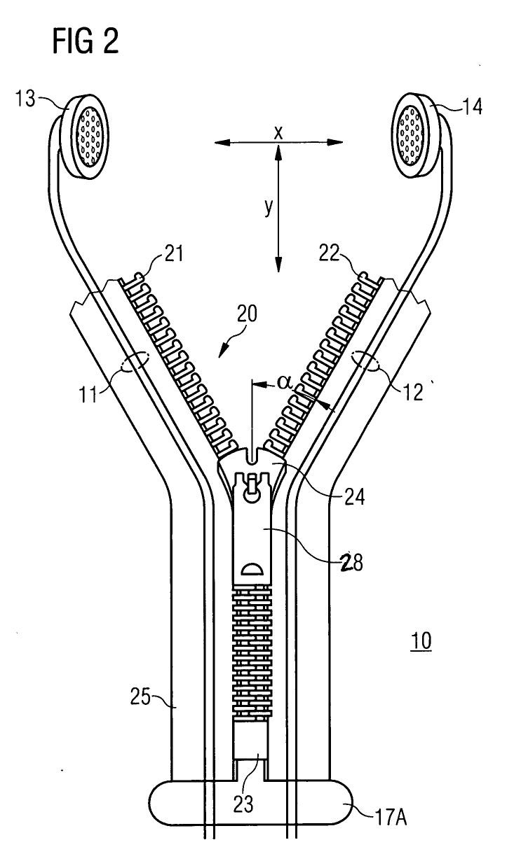

FIG. 2 illustrates a headset wire 10 where the slidable connector 18 includes a zipper 20. The zipper 20 includes two rows of hooks 21, 22 that are fastened to an extension of insulating material 25, which may be the insulating material around the wire pairs 11, 12. Typically, this is some polymer material but can be of practically any insulating material whose elastic properties are satisfactory for the purpose.

The hooks 21, 22 are, as in a common zipper, joined together through the use of a conventional slider or slider means 24 provided with a usual operating tab 28. The slider 24 typically includes a Y-shape channel through which the hooks 21, 22 pass. At the end of the zipper 20 is an end member 23 prohibiting the slider 24 from moving beyond the area where hooks 21, 22 are located. The end member 23 can be integrated with the connector 17A, or it can be a separate member.

Additionally, the hooks 21, 22 can also be manufactured as recesses in the insulating material 25 of the wires.

Furthermore, the user can adjust the dimensions and the angle α of the headset by selecting the position of the slider 24. Typically a normal position of the headset slider can be divided in different size classes, such as those typically used in clothing industry (e.g., S, M, L, XL), to vary the headsets to accommodate the size of a particular user.

As another example, instead of traditional zipper hooks 21, 22, means of fastening accomplished by providing a male connecting member on a first side (not shown) and a female connecting member on a second side. These connecting members can be in a form of a recess and extension that stick together by pressing, for example.

Means of fastening can also be provided in the insulator of the wire pairs. Thus, when implemented with either a zipper, male and female connectors, or some other means of fastening, the last paragraph, the resulting system is particularly easy to manufacture and use.

As described above, the presently disclosed headset wire for a portable electronic device essentially suffers less from the phenomenon of entangled wires. This is achieved with the exemplary headset wire as described. With the disclosed headset wire, the number of entangling wires is reduced to one, thereby enhancing the comfort of use of the headset wire.

Although the invention was described above with reference to the examples shown in the appended drawings, it is obvious that the invention is not limited to these but may be modified by those skilled in the art without difference from the scope of the invention.

Although certain apparatus have been described herein, the scope of coverage of this patent is now limited thereto. On the contrary, this patent covers all apparatus fairly falling within the scope of the appended claims, either literally or under the doctrine of equivalents.

1. A headset wire for use with a portable electronic device comprising:
a first pair of wires configured to electrically connect to a first loudspeaker;
a second pair of wires configured to electrically connect to at least one of a microphone and a second loudspeaker; and
a zipper configured to releasably join the first and the second pair of wires together.

2. A headset wire as defined in claim 1, wherein the first and the second pair of wires further comprise hooks configured to stick together or to release from each other responsive to a movement of a slider element of the zipper.

3. A headset wire as defined in claim 2, wherein the first and the second pair of wires are connected to the hooks with a same material that is used for providing electrical insulation for the first and second pair of wires.

4. A headset wired as defined in claim 3, wherein the same material is a polymer.

5. A headset wire as defined in claim 1, wherein movement of the zipper is restricted by a connector for connecting the headset wire to the portable electronic device.
